(19) United States
(12) Patent Application Publication
(10) Pub. No.: US 2017/0176047 A1
(43) Pub. Date: Jun. 22, 2017

(54) PLATE-TYPE HEAT EXCHANGER, HOT WATER APPARATUS, AND METHOD FOR MANUFACTURING PLATE-TYPE HEAT EXCHANGER

(71) Applicant: NORITZ CORPORATION, Hyogo (JP)

(72) Inventor: Masaki KONDO, Himeji-shi (JP)

(73) Assignee: NORITZ CORPORATION, Hyogo (JP)

(21) Appl. No.: 15/377,037

(22) Filed: Dec. 13, 2016

(30) Foreign Application Priority Data
Dec. 18, 2015 (JP) 2015-247584

(51) Int. Cl. F24H 1/12; B23P 15/26; F28D 9/00

(52) U.S. Cl. CPC F24H 1/124; F28D 9/0025; B23P 15/26

(57) ABSTRACT

A plate-type heat exchanger includes a first heat transfer plate and a second heat transfer plate. The first heat transfer plate has a joint projection portion. The second heat transfer plate has a joint recess portion in which the joint projection portion is fitted. The joint projection portion and the joint recess portion are brazed to each other.

### BACKGROUND OF THE INVENTION

Field of the Invention

The present invention relates to a plate-type heat exchanger, a hot water apparatus, and a method for manufacturing a plate-type heat exchanger.

Description of the Background Art

A plate-type heat exchanger is disclosed, for example, in Japanese Patent Laying-Open No. 2014-214934, Japanese Patent Laying-Open No. 6-194083, and Japanese Patent Laying-Open No. 2013-29296.

Japanese Patent Laying-Open No. 2014-214934 and Japanese Patent Laying-Open No. 6-194083 disclose joint by brazing between heat transfer plates superimposed on each other.

Japanese Patent Laying-Open No. 2013-29296 discloses brazing between a first plate and a second plate. A top portion of a dimple of the first plate is in contact with a bottom surface of the second plate. A top portion of a dimple of the second plate is in contact with a bottom portion of the first plate.

When brazeability between plates is poor in the three publications, a crack is produced in the plate and a fluid which flows in the inside leaks. In brazing, when a brazing material flows to a portion other than a portion which has to be brazed, the brazing material is wasted.

### SUMMARY OF THE INVENTION

The present invention was made in view of the problems above, and an object thereof is to provide a plate-type heat exchanger which can achieve good brazeability between plates and suppression of waste of a brazing material, a hot water apparatus, and a method for manufacturing a plate-type heat exchanger.

A plate-type heat exchanger according to the present invention includes a first plate and a second plate. The second plate is superimposed on the first plate. The first plate has a first joint projection portion. The second plate has a first joint recess portion in which the first joint projection portion is fitted. The first joint projection portion and the first joint recess portion are brazed to each other.

According to the plate-type heat exchanger in the present invention, the first joint projection portion and the first joint recess portion are brazed to each other while the first joint projection portion is fitted in the first joint recess portion. A brazed surface is thus a surface including projections and recesses and an area for brazing increases. Therefore, brazing can be secure and brazeability is good.

As the first joint projection portion and the first joint recess portion are brazed to each other, the brazing material is less likely to leak from the first joint recess portion. Therefore, leakage of the brazing material to a portion other than a portion which has to be brazed is less likely and waste of the brazing material is suppressed.

In the plate-type heat exchanger, the first plate is a first heat transfer plate having first flow path concaves and convexes. The second plate is a second heat transfer plate having second flow path concaves and convexes.

Brazeability between the heat transfer plates can thus be good and waste of the brazing material can be suppressed.

In the plate-type heat exchanger, the first flow path concaves and convexes of the first heat transfer plate have a flow path concave portion. The first joint projection portion projects downward from a bottom portion of the flow path concave portion. The second flow path concaves and convexes of the second heat transfer plate have a flow path convex portion. The first joint recess portion is recessed downward from a top portion of the flow path convex portion.

Thus, the bottom portion of the flow path concave portion of the first heat transfer plate and the top portion of the flow path convex portion of the second heat transfer plate abut on each other, so that the first joint projection portion can be fitted in the first joint recess portion.

The plate-type heat exchanger further includes a third heat transfer plate and an external plate arranged outside the third heat transfer plate. Any one of the third heat transfer plate and the external plate has a second joint projection portion. Any the other of the third heat transfer plate and the external plate has a second joint recess portion in which the second joint projection portion is fitted. The second joint projection portion and the second joint recess portion are brazed to each other. In a plan view, a joint portion between the second joint projection portion and the second joint recess portion is superimposed on a joint portion between the first joint projection portion and the first joint recess portion.

The third heat transfer plate and the first heat transfer plate can thus be identical to each other in plate shape. Therefore, a heat transfer plate dedicated to brazing to an external plate is not necessary.

The plan view means a point of view for viewing the first plate and the second plate in a direction in which the first plate and the second plate are superimposed on each other.

In the plate-type heat exchanger, a depth of the first joint recess portion is equal to or smaller than a height of the second flow path concaves and convexes.

Blocking by the first joint recess portion, of a flow of a medium which flows through the flow path partitioned by the second flow path concaves and convexes is thus suppressed. Therefore, increase in resistance in the flow path by the first joint recess portion can be suppressed.

In the plate-type heat exchanger, the first flow path concaves and convexes of the first heat transfer plate have a first flat joint portion located around the entire circumference of the first joint projection portion. The second flow path concaves and convexes of the second heat transfer plate have a second flat joint portion located around the entire circumference of the first joint recess portion. The first flat joint portion and the second flat joint portion are brazed to each other as facing each other.

The first flat joint portion and the second flat joint portion are thus located around the entire circumferences of the first joint projection portion and the first joint recess portion, respectively. Thus, even when a brazing material leaks from between the first joint projection portion and the first joint recess portion, the first flat joint portion and the second flat joint portion are brazed by the leaked brazing material to each other. Therefore, flow of the brazing material to a portion which does not have to be brazed is suppressed.

The first flat joint portion and the second flat joint portion are located around the entire circumferences of the first joint projection portion and the first joint recess portion, respectively. Thus, break is less likely in each of the first heat transfer plate and the second heat transfer plate during press forming.

In the plate-type heat exchanger, the first plate is a heat transfer plate having first flow path concaves and convexes. The second plate is an external plate arranged outside the heat transfer plate.

Brazeability between the heat transfer plate and the external plate can thus be good and waste of the brazing material can be suppressed.

In the plate-type heat exchanger, each of the first joint projection portion and the first joint recess portion is annular in a plan view.

It thus becomes easy to form each of the first joint projection portion and the first joint recess portion. Registration between the first joint projection portion and the first joint recess portion is facilitated.

In the plate-type heat exchanger, the first joint projection portion and the first joint recess portion are substantially equal to each other in radius in a plan view.

The brazing material thus readily spreads over the entire region where the first joint projection portion and the first joint recess portion are opposed to each other. Therefore, a portion where a brazing material is not distributed is less likely to be present in the region where the first joint projection portion and the first joint recess portion are opposed to each other and dissatisfactory brazing is suppressed.

Being substantially equal means that there is no difference equal to or greater than 0.1 mm in radius between the first joint projection portion and the first joint recess portion.

In the plate-type heat exchanger, each of the first joint projection portion and the first joint recess portion has a corner portion in a cross-section along a direction in which the first plate and the second plate are superimposed on each other.

As each of the first joint projection portion and the first joint recess portion has a corner portion, an area for brazing increases and hence force of joint by brazing is improved.

A hot water apparatus according to the present invention includes the plate-type heat exchanger described above and a combustion apparatus which generates heating gas which exchanges heat with a medium in the plate-type heat exchanger.

According to the hot water apparatus in the present invention, brazeability between the first plate and the second plate is good. Therefore, a crack in the plate is less likely and leakage of a fluid which flows in the plate-type heat exchanger is less likely.

A method for manufacturing a plate-type heat exchanger according to the present invention includes steps below.

Initially, a first plate having a joint projection portion and a second plate having a joint recess portion are prepared. A brazing material is arranged in the joint recess portion of the second plate. The first plate and the second plate are superimposed on each other such that the joint projection portion of the first plate is fitted in the joint recess portion of the second plate with the brazing material being arranged in the joint recess portion. The joint recess portion and the joint projection portion are brazed to each other with the brazing material while the first plate and the second plate are superimposed on each other.

According to the method for manufacturing a plate-type heat exchanger in the present invention, the joint projection portion and the joint recess portion are brazed to each other with the joint projection portion being fitted in the joint recess portion. A brazed surface is thus a surface including projections and recesses and an area for brazing increases. Therefore, brazing can be secure and brazeability is good.

The joint projection portion and the joint recess portion are brazed to each other with the brazing material being arranged in the joint recess portion, so that the brazing material is less likely to leak from the first joint recess portion. Therefore, leakage of the brazing material to a portion other than a portion which has to be brazed is less likely and waste of the brazing material is suppressed.

As described above, according to the present invention, a plate-type heat exchanger and a hot water apparatus which can achieve good brazeability between plates and suppression of waste of a brazing material are provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing a construction of a plate-type heat exchanger in one embodiment of the present invention from a side of a top plate.

FIG. 2 is a perspective view schematically showing the construction of the plate-type heat exchanger in one embodiment of the present invention from a side of a bottom plate.

FIG. 3 is an exploded perspective view schematically showing the construction of the plate-type heat exchanger in one embodiment of the present invention from the side of the top plate.

FIG. 4 is a plan view schematically showing a construction of one of two upper and lower heat transfer plates included in the plate-type heat exchanger in one embodiment of the present invention.

FIG. 5 is a plan view schematically showing a construction of the other of the two upper and lower heat transfer plates included in the plate-type heat exchanger in one embodiment of the present invention.

FIG. 6 is a plan view showing superimposition of flow path concaves and convexes of a heat transfer plate pair included in the plate-type heat exchanger in one embodiment of the present invention.

FIG. 7 is a partial cutaway perspective view schematically showing the construction of the plate-type heat exchanger in one embodiment of the present invention.

FIG. 8 is a schematic plan view showing a construction of a joint projection portion and a joint recess portion provided in the plate-type heat exchanger in one embodiment of the present invention, for example, with a region R1 in FIG. 6 being enlarged.

FIG. 9 is a schematic cross-sectional view along the line IX-IX in FIG. 8 showing the construction of the joint projection portion and the joint recess portion provided in the plate-type heat exchanger in one embodiment of the present invention.

FIG. 10 is a schematic plan view showing a construction of a modification of the joint projection portion and the joint recess portion provided in the plate-type heat exchanger in one embodiment of the present invention.

FIG. 11 is a schematic cross-sectional view along the line IX-IX in FIG. 8 showing the construction of the modification of the joint projection portion and the joint recess portion provided in the plate-type heat exchanger in one embodiment of the present invention.

FIG. 12 is a partial cutaway perspective view for illustrating joint between a top plate and a heat transfer plate of the plate-type heat exchanger in one embodiment of the present invention.

FIG. 13 is a partial cutaway perspective view for illustrating joint between a bottom plate and a heat transfer plate of the plate-type heat exchanger in one embodiment of the present invention.

FIG. 14 is a partial cross-sectional view schematically showing a first step in a method for manufacturing a plate-type heat exchanger in one embodiment of the present invention.

FIG. 15 is a partial cross-sectional view schematically showing a second step in the method for manufacturing a plate-type heat exchanger in one embodiment of the present invention.

FIG. 16 is a partial cross-sectional view schematically showing a third step in the method for manufacturing a plate-type heat exchanger in one embodiment of the present invention.

FIG. 17 is an exploded perspective view schematically showing a construction of a modification of the plate-type heat exchanger in one embodiment of the present invention from the side of the top plate.

FIG. 18 is a partial cross-sectional view showing the construction of the modification of the plate-type heat exchanger in one embodiment of the present invention.

FIG. 19 is a diagram schematically showing a construction of a hot water apparatus including the plate-type heat exchanger in one embodiment of the present invention.

### DESCRIPTION OF THE PREFERRED EMBODIMENTS

An embodiment of the present invention will be described below with reference to the drawings.

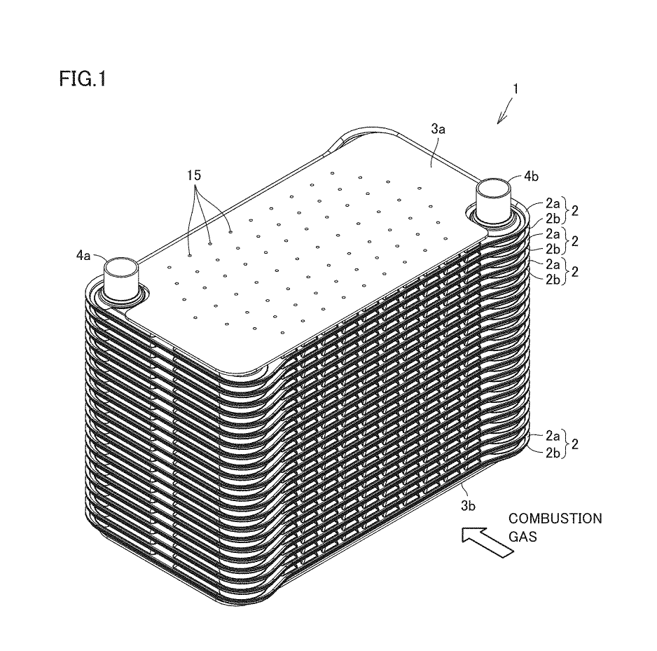

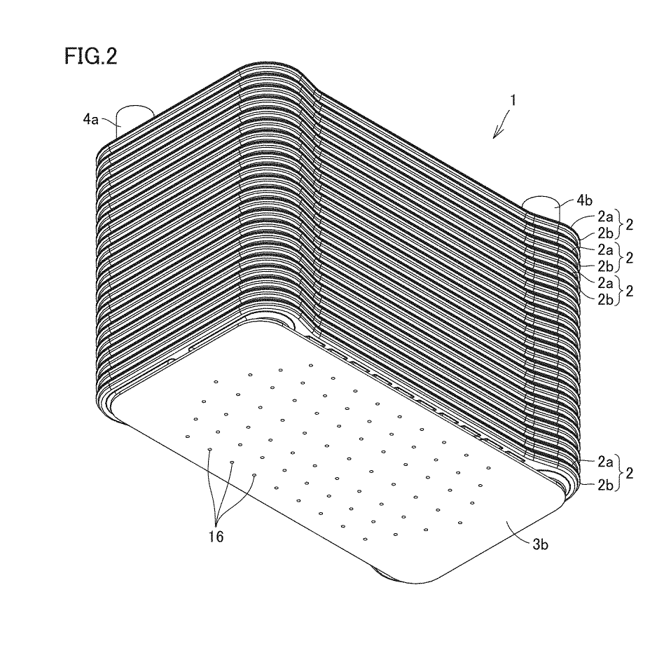

An overall construction of a plate-type heat exchanger in the present embodiment will initially be described with reference to FIGS. 1 to 3.

As shown in FIGS. 1 to 3, a plate-type heat exchanger 1 in the present embodiment mainly has a plurality of heat transfer plates 2a, a plurality of heat transfer plates 2b, a top plate (an external plate) 3a, and a bottom plate (an external plate) 3b.

The plurality of heat transfer plates 2a and the plurality of heat transfer plates 2b are stacked such that heat transfer plate 2a and heat transfer plate 2b are alternately arranged. Top plate 3a and bottom plate 3b are arranged to sandwich a plurality of heat transfer plates 2a and 2b.

One heat transfer plate 2a and one heat transfer plate 2b constitute a heat transfer plate pair 2. A space between heat transfer plate 2a and heat transfer plate 2b constituting heat transfer plate pair 2 defines a flow path through which a first medium such as water passes.

A space between heat transfer plate pairs 2 defines a flow path in which a second medium such as combustion gas flows. Each of a space between heat transfer plate pair 2 and top plate 3a and a space between heat transfer plate pair 2 and bottom plate 3b defines a flow path in which the second medium such as combustion gas flows. Heat can thus be exchanged between the first medium and the second medium which flow through plate-type heat exchanger 1.

Heat transfer plate 2a in an uppermost layer has two joints 4a and 4b. Each of two joints 4a and 4b is a joint for connection to a pipe. A flow path in each of two joints 4a and 4b is connected to an internal flow path in each of a plurality of heat transfer plate pairs 2.

A pipe connected to one of two joints 4a and 4b is a pipe for allowing the first medium to flow in an internal flow path in each of heat transfer plate pair 2. A pipe connected to the other of two joints 4a and 4b is a pipe for allowing the first medium to flow out of the internal flow path in each of heat transfer plate pair 2.

Through holes 2a3 and 2b3 are provided in heat transfer plates 2a and 2b, respectively. Each of through holes 2a3 and 2b3 communicates with the internal flow path in heat transfer plate pair 2. Though not shown in the figure, through hole 2a3 similar to those in other heat transfer plates 2a is provided also in heat transfer plate 2a in the uppermost layer to which joints 4a and 4b are connected.

Through holes 2a3 and 2b3 are arranged directly under joints 4a and 4b. Through holes 2a3 and 2b3 communicate with flow paths in joints 4a and 4b.

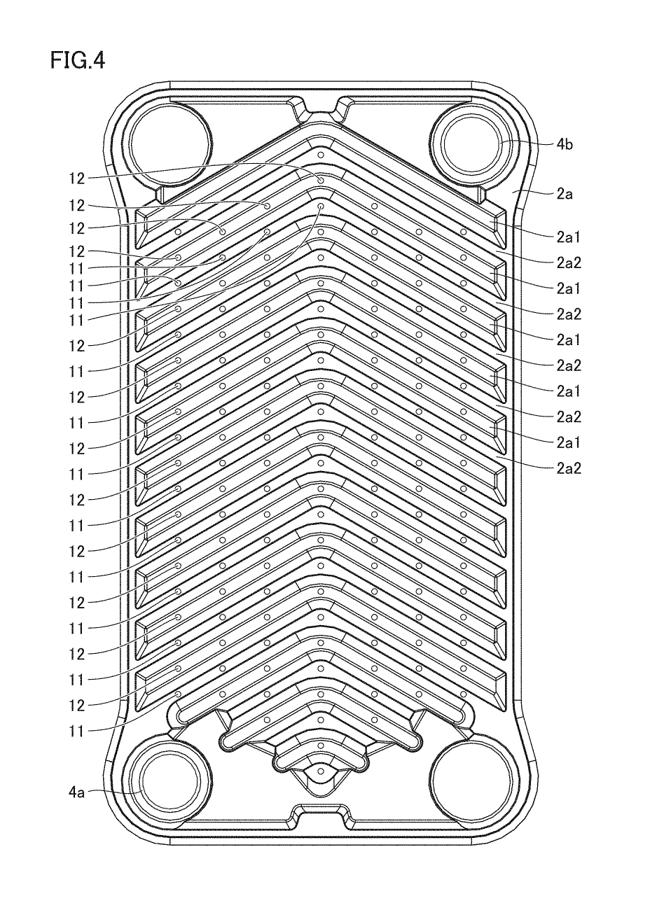

A construction of heat transfer plates 2a and 2b will now be described with reference to FIGS. 4 to 6.

As shown in FIG. 4, heat transfer plate 2a has, for example, a substantially rectangular outer geometry in a plan view. Heat transfer plate 2a is formed, for example, by working one flat plate by pressing.

Heat transfer plate 2a has flow path concaves and convexes formed by working above. The flow path concaves and convexes of heat transfer plate 2a have a plurality of flow path convex portions 2a1 and a plurality of flow path concave portions 2a2.

Each of the plurality of flow path convex portions 2a1 is a portion formed to project upward from the flat plate by working above. Each of the plurality of flow path convex portions 2a1 is, for example, in a V shape in a plan view.

Each of the plurality of flow path concave portions 2a2 is a portion recessed downward relative to the plurality of flow path convex portions 2a1. Each of the plurality of flow path concave portions 2a2 is, for example, in a V shape in a plan view. The V shape of the plurality of flow path convex portions 2a1 and the V shape of the plurality of flow path concave portions 2a2 are V shapes oriented in the same direction in a plan view.

Each of the plurality of flow path convex portions 2a1 has a joint recess portion 12. Joint recess portion 12 is recessed downward from a top portion of flow path convex portion 2a1. A plurality of joint recess portions 12 are provided in one flow path convex portion 2a1.

Each of the plurality of flow path concave portions 2a2 has a joint projection portion 11. Joint projection portion 11 projects downward from the bottom portion of flow path concave portion 2a2. A plurality of joint projection portions 11 are formed in one flow path concave portion 2a2.

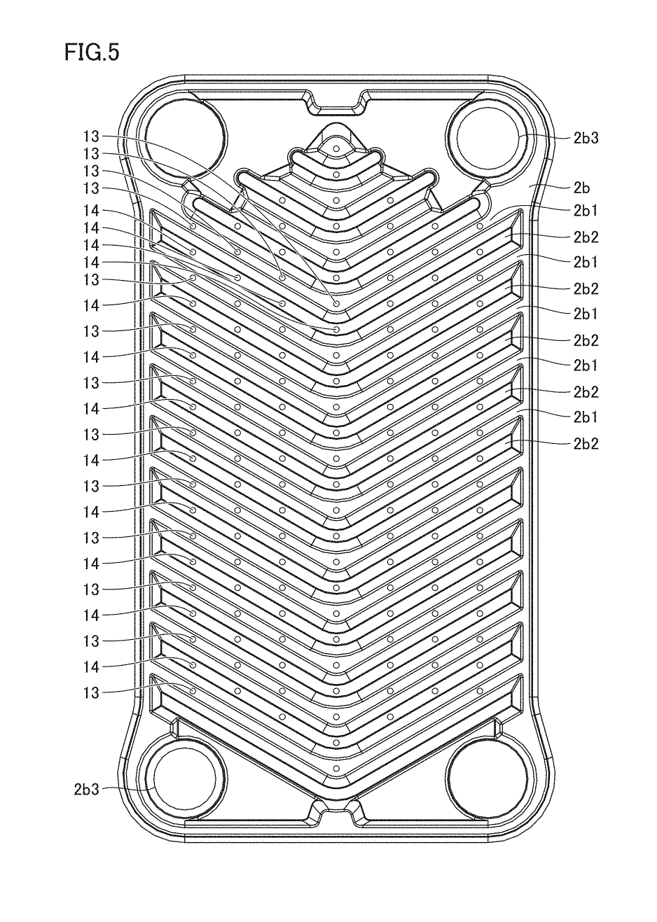

As shown in FIG. 5, heat transfer plate 2b has, for example, a substantially rectangular outer geometry in a plan view. Heat transfer plate 2b is formed, for example, by working one flat plate by pressing.

Heat transfer plate 2b has flow path concaves and convexes formed by working above. The flow path concaves and convexes of heat transfer plate 2b have a plurality of flow path convex portions 2b1 and a plurality of flow path concave portions 2b2. Heat transfer plate 2b is identical to heat transfer plate 2a, for example, in rectangular outer geometry.

Each of the plurality of flow path concave portions 2b2 is a portion formed to project downward from the flat plate by working above. Each of the plurality of flow path concave portions 2b2 is, for example, in a V shape in a plan view.

Each of the plurality of flow path convex portions 2b1 is a portion projecting upward relative to the plurality of flow path concave portions 2b2. Each of the plurality of flow path convex portions 2b1 is, for example, in a V shape in a plan view. The V shape of the plurality of flow path concave portions 2b2 and the V shape of the plurality of flow path convex portions 2b1 are V shapes oriented in the same direction in a plan view.

Each of the plurality of flow path convex portions 2b1 has a joint recess portion 13. Joint recess portion 13 is recessed downward from a top portion of flow path convex portion 2b1. A plurality of joint recess portions 13 are formed in one flow path convex portion 2b1.

Each of the plurality of flow path concave portions 2b2 has a joint projection portion 14. Joint projection portion 14 projects downward from the bottom portion of flow path concave portion 2b2. A plurality of joint projection portions 14 are formed in one flow path concave portion 2b2.

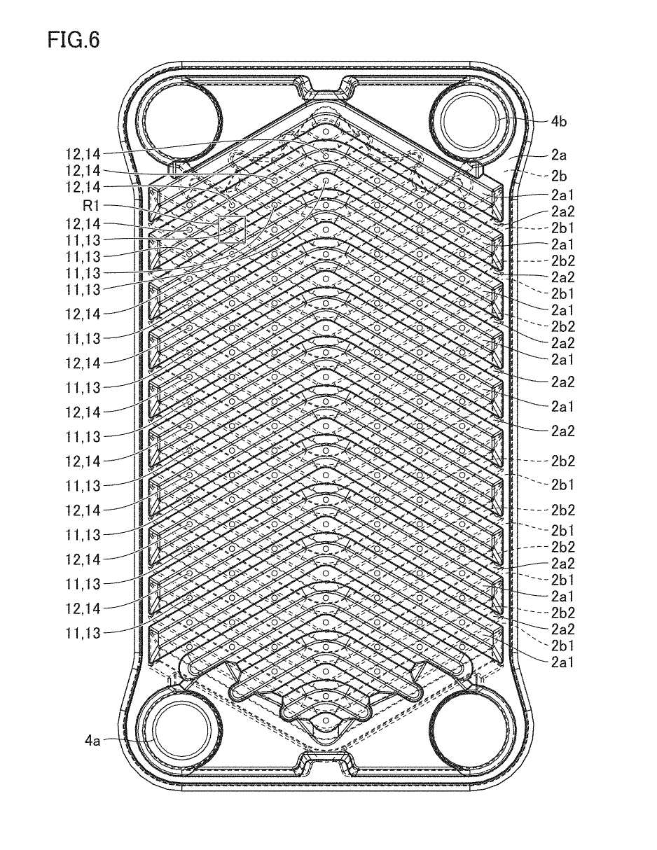

As shown in FIG. 6, heat transfer plate 2a and heat transfer plate 2b are superimposed on each other. The plates are superimposed on each other such that an edge of the substantially rectangular outer geometry of heat transfer plate 2a and an edge of the substantially rectangular outer geometry of heat transfer plate 2b meet each other in a plan view. Limitation to the substantially rectangular outer geometry of heat transfer plate 2a and the substantially rectangular outer geometry of heat transfer plate 2b being the same is not intended.

In the superimposed state above, the V shape of flow path convex portions 2a1 and flow path concave portions 2a2 and the V shape of flow path concave portions 2b2 and flow path convex portions 2b1 are opposite in orientation to each other in a plan view.

In the superimposed state above, each of joint projection portion 11 and joint recess portion 13 is provided at a position where flow path concave portion 2a2 and flow path convex portion 2b1 are superimposed on each other in a plan view. In the superimposed state above, joint projection portion 11 and joint recess portion 13 are also arranged at a position where they are superimposed on each other.

In the superimposed state above, each of joint recess portion 12 and joint projection portion 14 is provided at a position where flow path convex portion 2a1 and flow path concave portion 2b2 are superimposed on each other in a plan view. In the superimposed state above, joint recess portion 12 and joint projection portion 14 are also arranged at a position where they are superimposed on each other.

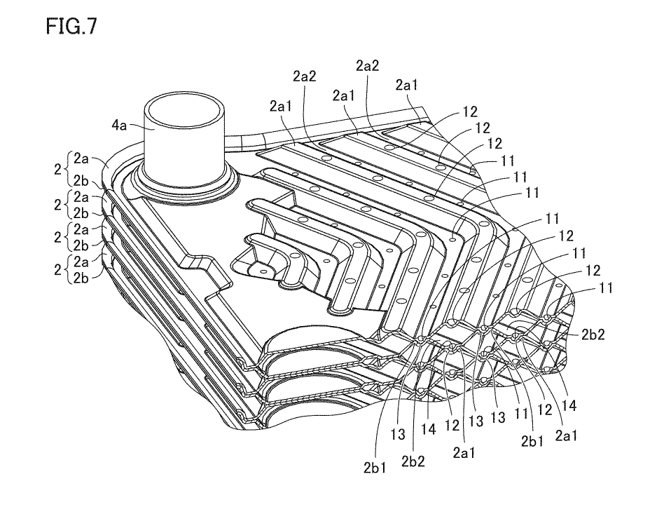

Joint by brazing between heat transfer plate 2a and heat transfer plate 2b will now be described with reference to FIGS. 7 to 11. FIG. 7 does not show top plate 3a on heat transfer plate 2a.

As shown in FIG. 7, with heat transfer plate 2a and heat transfer plate 2b being superimposed on each other, joint projection portion 11 of heat transfer plate 2a is fitted in joint recess portion 13 of heat transfer plate 2b. Joint projection portion 11 and joint recess portion 13 are brazed to each other in this state. As a result of brazing between joint projection portion 11 and joint recess portion 13, heat transfer plate 2a and heat transfer plate 2b constituting the same heat transfer plate pair 2 are joined to each other.

In the above description, heat transfer plate 2a corresponds, for example, to the “first heat transfer plate” and heat transfer plate 2b corresponds, for example, to the “second heat transfer plate.” Joint projection portion 11 of heat transfer plate 2a corresponds, for example, to the “first joint projection portion” and joint recess portion 13 of heat transfer plate 2b corresponds, for example, to the “first joint recess portion.”

In the superimposed state, joint projection portion 14 of heat transfer plate 2b is fitted in joint recess portion 12 of heat transfer plate 2a. Joint projection portion 14 and joint recess portion 12 are brazed to each other in this state. As a result of brazing between joint projection portion 14 and joint recess portion 12, heat transfer plate 2a of one heat transfer plate pair 2 and heat transfer plate 2b of another heat transfer plate pair 2 are joined to each other.

In the above description, heat transfer plate 2b corresponds, for example, to the “first heat transfer plate” and heat transfer plate 2a corresponds, for example, to the “second heat transfer plate.” Joint projection portion 14 of heat transfer plate 2b corresponds, for example, to the “first joint projection portion” and joint recess portion 12 of heat transfer plate 2a corresponds, for example, to the “first joint recess portion.”

As described above, heat transfer plate 2a and heat transfer plate 2b constituting the same heat transfer plate pair 2 are joined to each other and heat transfer plate 2a and heat transfer plate 2b constituting a different heat transfer plate pair 2 are joined to each other, so that a plurality of heat transfer plates 2a and 2b are joined as being stacked.

As shown in FIG. 8, with heat transfer plate 2a and heat transfer plate 2b being superimposed on each other, joint projection portion 11 of heat transfer plate 2b is superimposed on joint recess portion 13 of heat transfer plate 2a in a plan view and fitted in joint recess portion 13. Each of joint projection portion 11 and joint recess portion 13 is, for example, annular in a plan view. In a plan view, joint projection portion 11 and joint recess portion 13 are substantially equal to each other in radius.

Being substantially equal means that that there is no difference equal to or greater than 0.1 mm in radius between joint projection portion 11 and joint recess portion 13. Actually, a brazing material is arranged between joint projection portion 11 and joint recess portion 13 and a thickness of the brazing material is smaller than 0.1 mm. FIGS. 6 to 13 do not show a brazing material for the sake of convenience of drafting drawings.

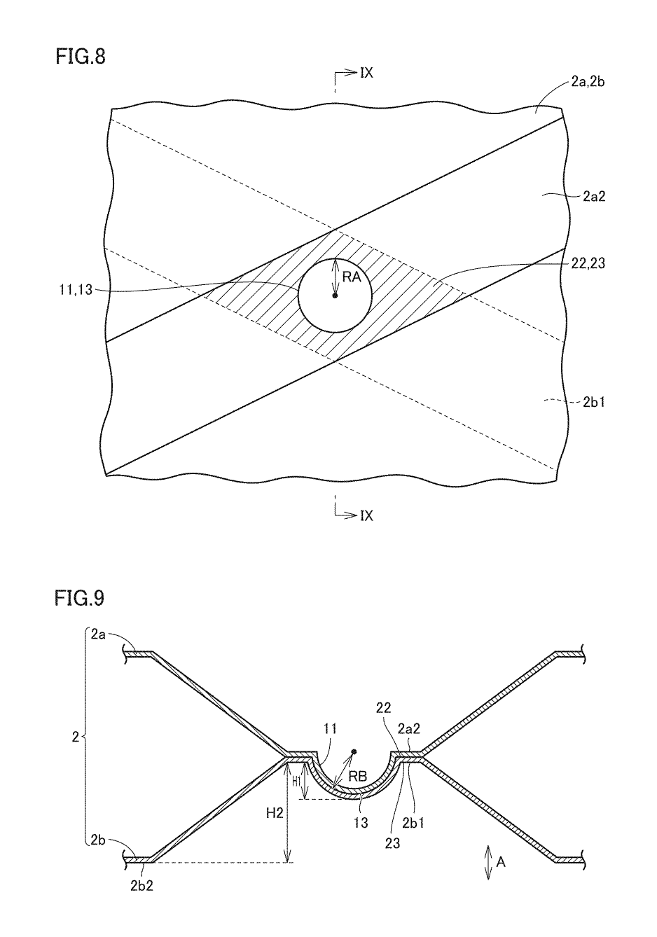

As shown in FIGS. 8 and 9, flow path concave portion 2a2 has a flat joint portion 22 (a hatched region in FIG. 8). Flat joint portion 22 is superimposed on flow path convex portion 2b1 in a plan view. Flat joint portion 22 is located around the entire circumference of joint projection portion 11 in a plan view. Flat joint portion 22 is in a rhombic shape in a plan view.

Flow path convex portion 2b1 has a flat joint portion 23 (a hatched region in FIG. 8). Flat joint portion 23 is superimposed on flow path concave portion 2a2 in a plan view. Flat joint portion 23 is located around the entire circumference of joint recess portion 13 in a plan view. Flat joint portion 23 is in a rhombic shape in a plan view.

Flat joint portion 22 of flow path concave portion 2a2 and flat joint portion 23 of flow path convex portion 2b1 may be joined to each other by brazing as facing each other.

As shown in FIG. 9, each of joint projection portion 11 and joint recess portion 13 is in an arc shape in a cross-section (a cross-section shown in FIG. 9) along a direction in which heat transfer plate 2a and heat transfer plate 2b are superimposed on each other. A radius RB of an outer circumferential surface of joint projection portion 11 is substantially equal to a radius RB of an inner circumferential surface of joint recess portion 13. Being substantially equal means that there is no difference equal to or greater than 0.1 mm in radius between joint projection portion 11 and joint recess portion 13 similarly to the above.

A depth H1 of joint recess portion 13 is equal to or smaller than a height H2 of the flow path concaves and convexes. Depth H1 of joint recess portion 13 is an amount of recess of joint recess portion 13 downward from the top portion of flow path convex portion 2b1 in the direction in which heat transfer plate 2a and heat transfer plate 2b are superimposed on each other (a direction shown with A in the figure). Depth H1 of joint recess portion 13 refers to a distance from flat joint portion 23 to the bottom portion of joint recess portion 13 in the direction of superimposition (the A direction).

Height H2 of the flow path concaves and convexes refers to an amount of projection of flow path convex portion 2b1 relative to flow path concave portion 2b2 in the direction of superimposition (the A direction). Height H2 of the flow path concaves and convexes refers to a distance from flat joint portion 23 to flow path concave portion 2b2 in the direction of superimposition (the A direction).

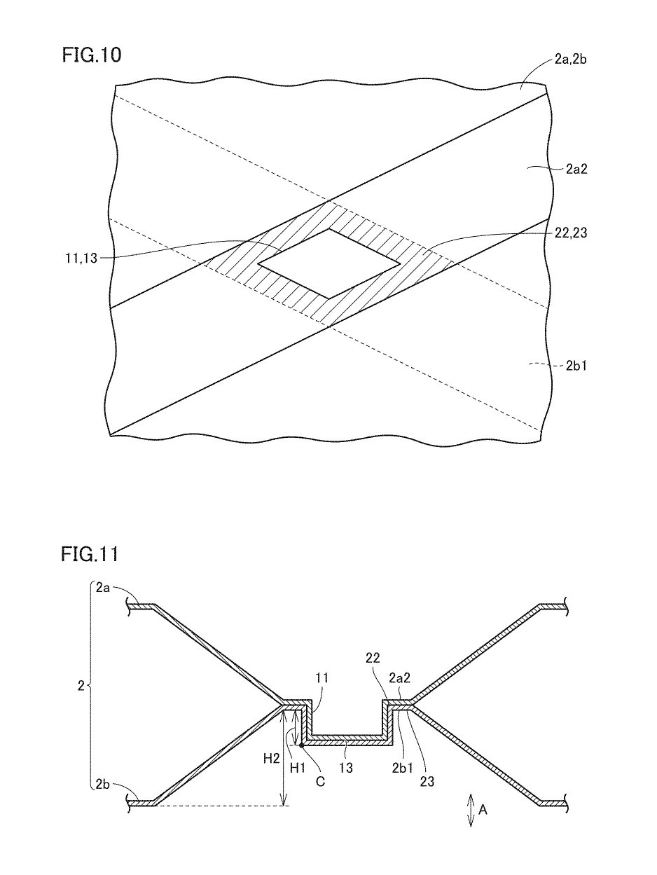

As shown in FIG. 10, each of joint projection portion 11 and joint recess portion 13 may be, for example, rectangular in a plan view. In this case, each of joint projection portion 11 and joint recess portion 13 in a plan view may be rhombic in a plan view. The rhombic shape in the plan view of each of joint projection portion 11 and joint recess portion 13 may be a shape similar to the rhombic shape in the plan view of flat joint portions 22 and 23.

As shown in FIG. 11, each of joint projection portion 11 and joint recess portion 13 may have a corner portion C in a cross-section (a cross-section shown in FIG. 11) along the direction in which heat transfer plate 2a and heat transfer plate 2b are superimposed on each other. In this case as well, depth H1 of joint recess portion 13 is preferably equal to or smaller than height H2 of the flow path concaves and convexes.

Though joint projection portion 11 and joint recess portion 13 are described above, joint projection portion 14 and joint recess portion 12 may be constructed similarly to joint projection portion 11 and joint recess portion 13 shown in FIGS. 8 to 11. Each of the flat joint portion located around joint projection portion 14 and the flat joint portion located around joint recess portion 12 may be constructed similarly to each of flat joint portion 22 and flat joint portion 23 shown in FIGS. 8 to 11.

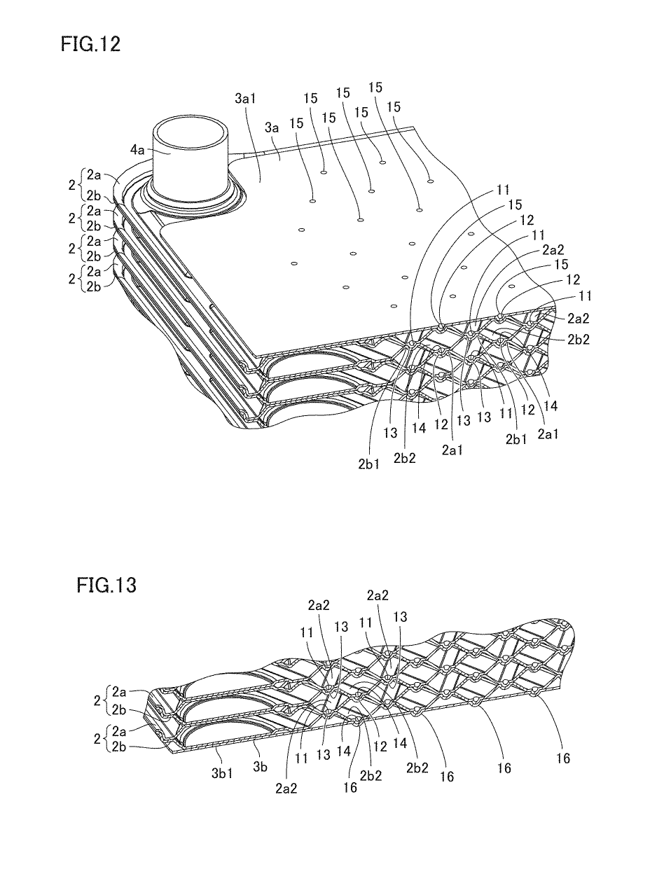

Brazing between top plate 3a and heat transfer plate 2a will be described with reference to FIG. 12 and brazing between bottom plate 3b and heat transfer plate 2b will be described with reference to FIG. 13.

As shown in FIG. 12, top plate 3a has a flat plate portion 3a1 and a plurality of joint projection portions 15. Each of the plurality of joint projection portions 15 projects downward from flat plate portion 3a1.

With top plate 3a and heat transfer plate 2a being superimposed on each other, joint projection portion 15 of top plate 3a is fitted in joint recess portion 12 of heat transfer plate 2a. Joint projection portion 15 and joint recess portion 12 are brazed to each other in this state. As a result of brazing between joint projection portion 15 and joint recess portion 12, top plate 3a and heat transfer plate 2a directly under top plate 3a are joined to each other.

In a plan view, the joint portion between joint projection portion 15 and joint recess portion 12 is superimposed on a joint portion between joint projection portion 14 of heat transfer plate 2b and joint recess portion 12 of heat transfer plate 2a.

In the description above, heat transfer plate 2a located directly under top plate 3a corresponds, for example, to the “third heat transfer plate” and top plate 3a corresponds, for example, to the “external plate.” Joint projection portion 15 of top plate 3a corresponds, for example, to the “second joint projection portion” and joint recess portion 12 of heat transfer plate 2a corresponds, for example, to the “second joint recess portion.”

As shown in FIG. 8, each of joint projection portion 15 and joint recess portion 12 may be, for example, annular in a plan view. In this case, in the plan view, joint projection portion 15 and joint recess portion 12 are preferably substantially equal to each other in radius.

Each of joint projection portion 15 and joint recess portion 12 may be rectangular (for example, rhombic) as shown in FIG. 10.

As shown in FIG. 9, each of joint projection portion 15 and joint recess portion 12 is in an arc shape in a cross-section along the direction in which top plate 3a and heat transfer plate 2a are superimposed on each other. The outer circumferential surface of joint projection portion 15 is substantially the same in radius to the inner circumferential surface of joint recess portion 12. Depth H1 of joint recess portion 12 is equal to or smaller than height H2 of the flow path concaves and convexes.

As shown in FIG. 11, each of joint projection portion 15 and joint recess portion 12 may have a corner portion in a cross-section along a direction in which top plate 3a and heat transfer plate 2a are superimposed on each other. In this case as well, depth H1 of joint projection portion 15 is preferably equal to or smaller than height H2 of the flow path concaves and convexes.

As shown in FIG. 13, bottom plate 3b has a flat plate portion 3b1 and a plurality of joint recess portions 16. Each of the plurality of joint recess portions 16 is recessed downward from flat plate portion 3b1.

With heat transfer plate 2b and bottom plate 3b being superimposed on each other, joint projection portion 14 of heat transfer plate 2b is fitted in joint recess portion 16 of bottom plate 3b. Joint projection portion 14 and joint recess portion 16 are brazed to each other in this state. As a result of brazing between joint projection portion 14 and joint recess portion 16, bottom plate 3b and heat transfer plate 2b directly on bottom plate 3b are joined to each other.

In a plan view, the joint portion between joint projection portion 14 and joint recess portion 16 is superimposed on a joint portion between joint projection portion 14 of heat transfer plate 2b and joint recess portion 12 of heat transfer plate 2a.

In the description above, heat transfer plate 2b located directly on bottom plate 3b corresponds, for example, to the “third heat transfer plate” and bottom plate 3b corresponds, for example, to the “external plate.” Joint projection portion 14 of heat transfer plate 2b corresponds, for example, to the “second joint projection portion” and joint recess portion 16 of bottom plate 3b corresponds, for example, to the “second joint recess portion.”

As shown in FIG. 8, each of joint projection portion 14 and joint recess portion 16 may be, for example, annular in a plan view. In this case, joint projection portion 14 and joint recess portion 16 are preferably equal to each other in radius in a plan view.

As shown in FIG. 10, each of joint projection portion 14 and joint recess portion 16 may be rectangular (for example, rhombic).

As shown in FIG. 9, each of joint projection portion 14 and joint recess portion 16 may be in an arc shape in a cross-section along the direction in which heat transfer plate 2b and bottom plate 3b are superimposed on each other. The outer circumferential surface of joint projection portion 14 is substantially equal in radius to the inner circumferential surface of joint recess portion 16. Depth H1 of joint recess portion 16 is equal to or smaller than height H2 of the flow path concaves and convexes.

As shown in FIG. 11, each of joint projection portion 14 and joint recess portion 16 may have a corner portion in a cross-section along the direction in which bottom plate 3b and heat transfer plate 2b are superimposed on each other. In this case as well, depth H1 of joint recess portion 16 is preferably equal to or smaller than height H2 of the flow path concaves and convexes.

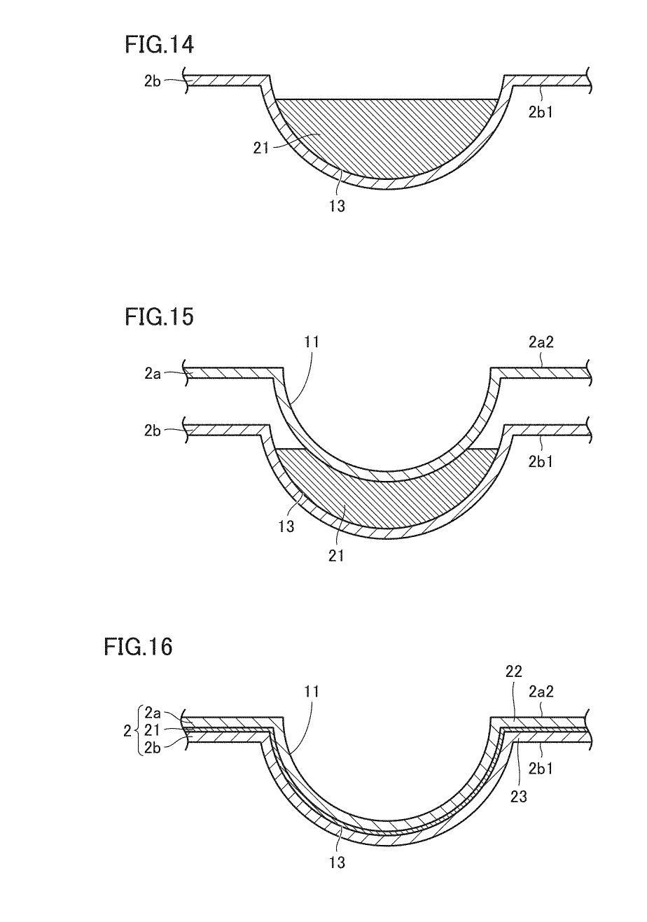

A method for manufacturing plate-type heat exchanger 1 in the present embodiment will now be described with reference to FIGS. 14 to 16.

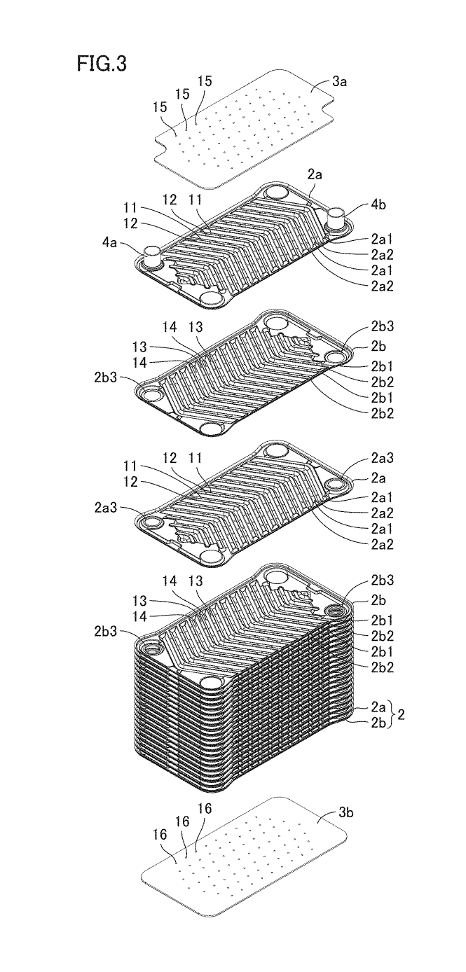

Initially, as shown in FIG. 3, top plate 3a, heat transfer plate 2a, heat transfer plate 2b, and bottom plate 3b are prepared. Top plate 3a is prepared to have joint projection portions 15. Heat transfer plate 2a is prepared to have joint projection portions 11 and joint recess portions 12. Heat transfer plate 2b is prepared to have joint projection portions 14 and joint recess portions 13. Bottom plate 3b is prepared to have joint recess portions 16.

Thereafter, top plate 3a and heat transfer plate 2a are joined to each other by brazing. Heat transfer plate 2a and heat transfer plate 2b which are to constitute the same heat transfer plate pair 2 are joined to each other by brazing. Heat transfer plate 2a and heat transfer plate 2b which are to constitute different heat transfer plate pair 2 are joined to each other by brazing. Heat transfer plate 2b and bottom plate 3b are joined to each other by brazing.

Since a method of joint by brazing is the same in each case, an example of joint between heat transfer plate 2a and heat transfer plate 2b constituting the same heat transfer plate pair 2 by brazing will be described below as a representative example.

As shown in FIG. 14, a brazing material 21 is arranged in joint recess portion 13 of heat transfer plate 2b. Brazing material 21 is arranged in joint recess portion 2b, for example, with a dispenser. Brazing material 21 is composed, for example, of a metal material containing nickel (Ni).

As shown in FIG. 15, with brazing material 21 being arranged in joint recess portion 13, heat transfer plate 2a and heat transfer plate 2b are superimposed on each other such that joint projection portion 11 of heat transfer plate 2a is fitted in joint recess portion 13 of heat transfer plate 2b.

As shown in FIG. 16, with heat transfer plate 2a and heat transfer plate 2b being superimposed on each other, joint recess portion 13 and joint projection portion 11 are brazed to each other with brazing material 21. Here, flat joint portion 22 and flat joint portion 23 may be brazed to each other with the brazing material.

As each plate is thus brazed, plate-type heat exchanger 1 in the present embodiment is manufactured.

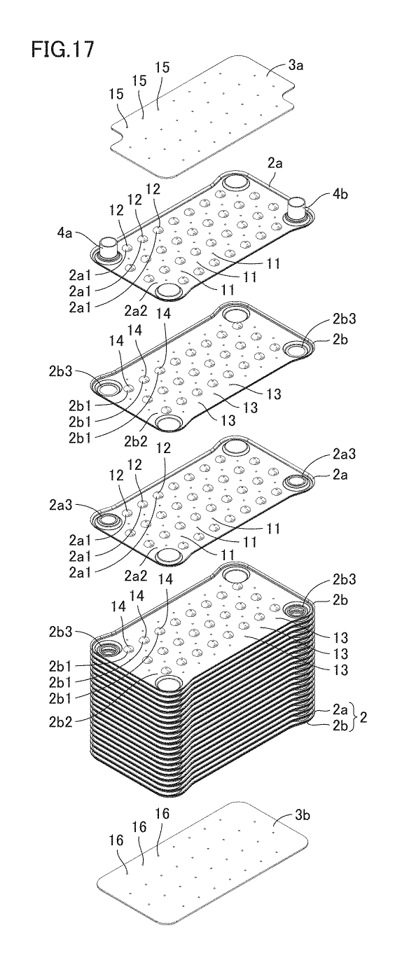

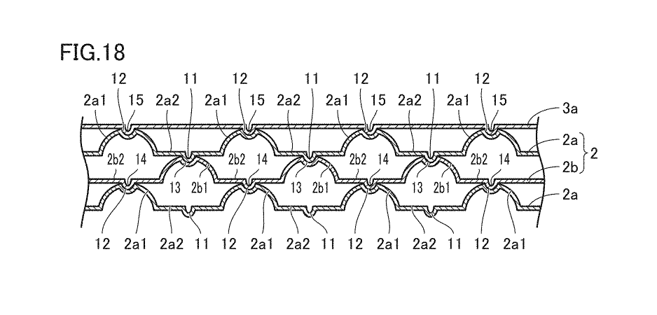

Though an example in which flow path convex portions 2a1 and 2b1 are in a V shape in a plan view as shown in FIGS. 3 to 5 is described above, each of flow path convex portions 2a1 and 2b1 may be an annular or rectangular projection portion in a plan view as shown in FIGS. 17 and 18.

When each of flow path convex portions 2a1 and 2b1 is annular in a plan view, each of flow path convex portions 2a1 and 2b1 may be a spherical (for example, a hemispherical) projection portion.

Joint recess portions 12 and 14 are provided at top portions of flow path convex portions 2a1 and 2b1, respectively. One joint recess portion 12 is provided for one flow path convex portion 2a1. One joint recess portion 13 is provided for one flow path convex portion 2b1.

Since features other than the features shown in FIGS. 17 and 18 are substantially the same as the features shown in FIGS. 1 to 13, the same elements have the same references allotted and description thereof will not be repeated. Since the method for manufacturing the construction shown in FIGS. 17 and 18 is substantially the same as the manufacturing method shown in FIGS. 14 to 16, description thereof will not be repeated either.

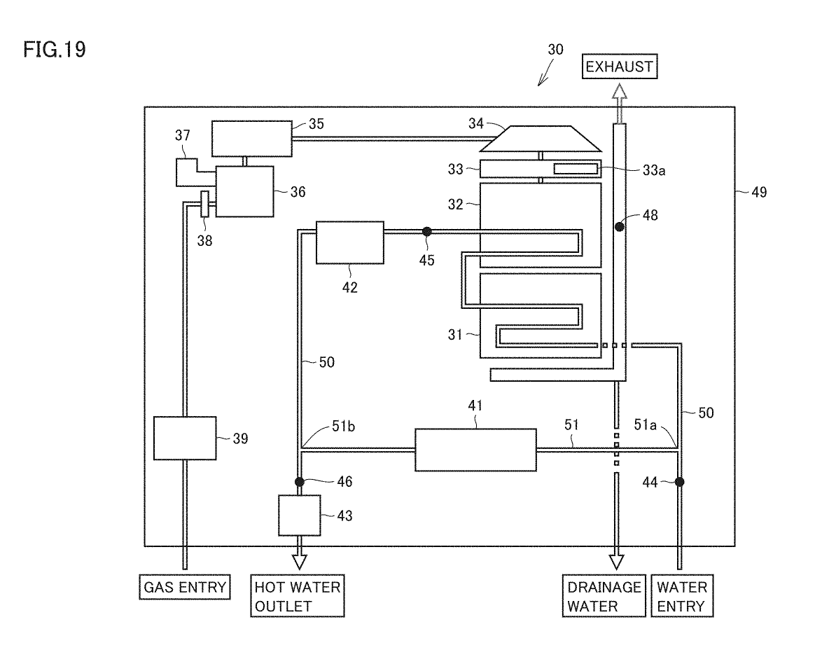

One example of a construction of a hot water apparatus to which the plate-type heat exchanger is applied will now be described with reference to FIG. 19.

As shown in FIG. 19, a hot water apparatus 30 mainly has a fan 35, a burner 33, a primary heat exchanger 32, a secondary heat exchanger 31, and a housing 49. Fan 35, burner 33, primary heat exchanger 32, and secondary heat exchanger 31 are arranged in housing 49.

Fan 35 serves to send a gas mixture of air taken from the outside of housing 49 and combustion gas to burner 33. Fan 35 has a fan case, an impeller arranged in the fan case, and a drive source (such as a motor) for rotating the impeller. The combustion gas flows to a venturi 36 through a gas valve 39 and an orifice 38. Gas valve 39 serves to control a flow rate of the combustion gas. Air taken from the outside of housing 49 flows to venturi 36 through a silencer 37.

The combustion gas and air are mixed in venturi 36. Venturi 36 serves to increase a flow velocity of a gas mixture by reducing a flow of the gas mixture of the combustion gas and air. The gas mixture which has passed through venturi 36 is sent to burner 33 through a chamber 34 by fan 35.

Burner 33 serves to supply the combustion gas to primary heat exchanger 32 and secondary heat exchanger 31. The gas mixture blown from burner 33 is ignited by an igniter 33a and becomes the combustion gas.

The combustion gas sequentially passes through primary heat exchanger 32 and secondary heat exchanger 31. Thereafter, the combustion gas is emitted to the outside of housing 49 through a duct 47. An exhaust thermistor 48 is arranged in duct 47.

Each of primary heat exchanger 32 and secondary heat exchanger 31 serves for heat exchange by using the combustion gas supplied by burner 33. Primary heat exchanger 32 is attached under burner 33 and secondary heat exchanger 31 is attached under primary heat exchanger 32.

Primary heat exchanger 32 is a heat exchanger for recovering sensible heat of the combustion gas and secondary heat exchanger 31 is a heat exchanger for recovering latent heat of the combustion gas. Water vapor in the combustion gas is condensed in secondary heat exchanger 31 and condensed water (drainage water) is produced. Drainage water is drained to the outside of housing 49 through a part of duct 47.

Primary heat exchanger 32 and secondary heat exchanger 31 are connected to each other through a pipe 50. A portion of pipe 50 on a side of water entry relative to secondary heat exchanger 31 and a portion of pipe 50 on a side of hot water outlet relative to primary heat exchanger 32 are bypassed by a bypass pipe 51. A bypass flow rate regulation valve 41 is arranged in bypass pipe 51.

A water entry thermistor 44 is arranged on the side of water entry relative to a connection portion 51a between pipe 50 and bypass pipe 51. An excess flow servo 43 and a hot water outlet thermistor 46 are arranged on the side of hot water outlet relative to a connection portion 51b between pipe 50 and bypass pipe 51. A high limit switch 42 and a can body exit thermistor 45 are arranged between connection portion 51b and primary heat exchanger 32. High limit switch 42 is a safety device which operates when a heat exchanger abnormally becomes hot.

Water supplied to hot water apparatus 30 becomes hot water as a result of heat exchange with the combustion gas in primary heat exchanger 32 and secondary heat exchanger 31. Hot water can thus be supplied by hot water apparatus 30.

Plate-type heat exchanger 1 in the present embodiment is applied, for example, to secondary heat exchanger 31 in hot water apparatus 30. Plate-type heat exchanger 1 in the present embodiment may be applied to primary heat exchanger 32.

A function and effect of the present embodiment will now be described.

According to the present embodiment, with joint projection portion 11 being fitted in joint recess portion 13 as shown in FIG. 9, joint projection portion 11 and joint recess portion 13 are brazed to each other. Thus, the brazed surface is the surface including projections and recesses and an area for brazing increases. Therefore, brazing can be secure and brazeability is good.

By brazing joint projection portion 11 and joint recess portion 13 to each other, brazing material 21 is less likely to leak from joint recess portion 13. Therefore, leakage of brazing material 21 to a portion other than a portion which has to be brazed is less likely and waste of brazing material 21 is suppressed.

Brazeability is good and waste of brazing material 21 is suppressed similarly also in the joint portion between joint projection portion 14 and joint recess portion 12 (FIG. 7), the joint portion between joint projection portion 15 and joint recess portion 12 (FIG. 12), and the joint portion between joint projection portion 14 and joint recess portion 16 (FIG. 13).

By applying a brazing structure in the present embodiment to brazing between heat transfer plate 2a and heat transfer plate 2b, brazeability between heat transfer plates 2a and 2b can be good and waste of brazing material 21 can be suppressed.

By applying the brazing structure in the present embodiment to brazing between top plate 3a and heat transfer plate 2a or brazing between bottom plate 3b and heat transfer plate 2b, brazeability can be good and waste of brazing material 21 can be suppressed in brazing between top plate 3a and heat transfer plate 2a and brazing between bottom plate 3b and heat transfer plate 2b.

As shown in FIG. 12, in a plan view, the joint portion between joint projection portion 15 of top plate 3a and joint recess portion 12 of heat transfer plate 2a is superimposed on the joint portion between joint projection portion 14 of heat transfer plate 2b and joint recess portion 12 of heat transfer plate 2a. Thus, heat transfer plate 2a joined to top plate 3a can be identical to other heat transfer plates 2a in plate shape. Therefore, a heat transfer plate dedicated to brazing to top plate 3a is not necessary.

As shown in FIG. 13, in a plan view, the joint portion between joint projection portion 14 of heat transfer plate 2b and joint recess portion 16 of bottom plate 3b is superimposed on the joint portion between joint projection portion 14 of heat transfer plate 2b and joint recess portion 12 of heat transfer plate 2a. Thus, heat transfer plate 2b joined to bottom plate 3b can be identical to other heat transfer plates 2b in plate shape. Therefore, a heat transfer plate dedicated to brazing to bottom plate 3b is not necessary.

As shown in FIG. 9, depth H1 of joint recess portion 13 is equal to or smaller than height H2 of the flow path concaves and convexes. Thus, increase in resistance in the flow path for a medium which flows through the flow path partitioned by the flow path concaves and convexes can be suppressed.

By setting similar height H1 for joint recess portion 12, increase in resistance in the flow path for a medium can be suppressed similarly to the above.

As shown in FIG. 9, flat joint portion 22 of heat transfer plate 2a and flat joint portion 23 of heat transfer plate 2b are located around the entire circumferences of joint projection portion 11 and joint recess portion 13, respectively. Thus, even though brazing material 21 leaks from between joint projection portion 11 and joint recess portion 13, flat joint portion 22 and flat joint portion 23 are brazed to each other by leaked brazing material 21. Therefore, flow of brazing material 21 to a portion which does not have to be brazed is suppressed.

Since flat joint portion 22 and flat joint portion 23 are located around the entire circumferences of joint projection portion 11 and joint recess portion 13, respectively, break is less likely in each of heat transfer plates 2a and 2b during press forming.

In the flat joint portion located around the entire circumference of joint recess portion 12 of heat transfer plate 2a and the flat joint portion located around the entire circumference of joint projection portion 14 of heat transfer plate 2b as well, similarly to the above, flow of brazing material 21 to a portion which does not have to be brazed is suppressed and break of each of heat transfer plates 2a and 2b can be suppressed.

As shown in FIG. 8, each of joint projection portions 11 and 14 and joint recess portions 12 and 13 is annular in a plan view. It thus becomes easy to form each of joint projection portions 11 and 14 and joint recess portions 12 and 13. Registration of each of joint projection portions 11 and 14 and joint recess portions 12 and 13 is facilitated.

As shown in FIG. 8, joint projection portion 11 and joint recess portion 13 are substantially equal to each other in radius in a plan view. Thus, brazing material 21 readily spreads over a region where joint projection portion 11 and joint recess portion 13 are opposed to each other. Therefore, a portion where brazing material 21 is not distributed is less likely to be present in the region where joint projection portion 11 and joint recess portion 13 are opposed to each other and dissatisfactory brazing is suppressed.

As joint projection portion 14 and joint recess portion 12 are substantially equal to each other in radius in a plan view, dissatisfactory brazing is suppressed similarly to the above.

As shown in FIG. 11, each of joint projection portion 11 and joint recess portion 13 has corner portion C, so that an area for brazing increases and hence force of joint by brazing is improved. Each of joint projection portion 14 and joint recess portion 12 has corner portion C, so that force of joint by brazing is improved similarly to the above.

As shown in FIG. 19, according to hot water apparatus 30 in the present embodiment, each of brazeability between top plate 3a and heat transfer plate 2a, brazeability between bottom plate 3b and heat transfer plate 2b, and brazeability between heat transfer plate 2a and heat transfer plate 2b is good, so that a crack in each plate is less likely and leakage of a fluid which flows through plate-type heat exchanger 31 is less likely.

Though the embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A plate-type heat exchanger comprising:
a first plate; and
a second plate superimposed on the first plate,
the first plate having a first joint projection portion and the second plate having a first joint recess portion in which the first joint projection portion is fitted, and
the first joint projection portion and the first joint recess portion being brazed to each other.

2. The plate-type heat exchanger according to claim 1, wherein
the first plate is a first heat transfer plate having first flow path concaves and convexes, and
the second plate is a second heat transfer plate having second flow path concaves and convexes.

3. The plate-type heat exchanger according to claim 2, wherein
the first flow path concaves and convexes of the first heat transfer plate have a flow path concave portion,
the first joint projection portion projects downward from a bottom portion of the flow path concave portion,
the second flow path concaves and convexes of the second heat transfer plate have a flow path convex portion, and
the first joint recess portion is recessed downward from a top portion of the flow path convex portion.

4. The plate-type heat exchanger according to claim 2, the plate-type heat exchanger further comprising:
a third heat transfer plate; and
an external plate arranged outside the third heat transfer plate, wherein
any one of the third heat transfer plate and the external plate has a second joint projection portion and any the other of the third heat transfer plate and the external plate has a second joint recess portion in which the second joint projection portion is fitted,
the second joint projection portion and the second joint recess portion are brazed to each other, and
in a plan view, a joint portion between the second joint projection portion and the second joint recess portion is superimposed on a joint portion between the first joint projection portion and the first joint recess portion.

5. The plate-type heat exchanger according to claim 2, wherein
a depth of the first joint recess portion is equal to or smaller than a height of the second flow path concaves and convexes.

6. The plate-type heat exchanger according to claim 2, wherein
the first flow path concaves and convexes of the first heat transfer plate have a first flat joint portion located around an entire circumference of the first joint projection portion,
the second flow path concaves and convexes of the second heat transfer plate have a second flat joint portion located around an entire circumference of the first joint recess portion, and
the first flat joint portion and the second flat joint portion are brazed to each other as facing each other.

7. The plate-type heat exchanger according to claim 2, wherein
each of the first joint projection portion and the first joint recess portion is annular in a plan view.

8. The plate-type heat exchanger according to claim 7, wherein
the first joint projection portion and the first joint recess portion are substantially equal to each other in radius in a plan view.

9. The plate-type heat exchanger according to claim 2, wherein
each of the first joint projection portion and the first joint recess portion has a corner portion in a cross-section along a direction in which the first plate and the second plate are superimposed on each other.

10. The plate-type heat exchanger according to claim 1, wherein
the first plate is a heat transfer plate having first flow path concaves and convexes, and
the second plate is an external plate arranged outside the heat transfer plate.

11. The plate-type heat exchanger according to claim 10, wherein
each of the first joint projection portion and the first joint recess portion is annular in a plan view.

12. The plate-type heat exchanger according to claim 11, wherein
the first joint projection portion and the first joint recess portion are substantially equal to each other in radius in a plan view.

13. The plate-type heat exchanger according to claim 10, wherein
each of the first joint projection portion and the first joint recess portion has a corner portion in a cross-section along a direction in which the first plate and the second plate are superimposed on each other.

14. The plate-type heat exchanger according to claim 1, wherein
each of the first joint projection portion and the first joint recess portion is annular in a plan view.

15. The plate-type heat exchanger according to claim 14, wherein
the first joint projection portion and the first joint recess portion are substantially equal to each other in radius in a plan view.

16. The plate-type heat exchanger according to claim 14, wherein
each of the first joint projection portion and the first joint recess portion has a corner portion in a cross-section along a direction in which the first plate and the second plate are superimposed on each other.

17. The plate-type heat exchanger according to claim 1, wherein
each of the first joint projection portion and the first joint recess portion has a corner portion in a cross-section along a direction in which the first plate and the second plate are superimposed on each other.

18. A hot water apparatus comprising:
the plate-type heat exchanger according to claim 1; and
a combustion apparatus which generates heating gas which exchanges heat with a medium in the plate-type heat exchanger.

19. A method for manufacturing a plate-type heat exchanger comprising:
preparing a first plate having a joint projection portion and a second plate having a joint recess portion;
arranging a brazing material in the joint recess portion of the second plate;
superimposing the first plate and the second plate on each other such that the joint projection portion of the first plate is fitted in the joint recess portion of the second plate with the brazing material being arranged in the joint recess portion; and
brazing the joint recess portion and the joint projection portion to each other with the brazing material while the first plate and the second plate are superimposed on each other.
